(19) United States
(12) Patent Application Publication
(10) Pub. No.: US 2006/0068789 A1
(43) Pub. Date: Mar. 30, 2006

(54) Radio configuration selection during inter-BS call handoff

(76) Inventors: Rath Vannithamby, San Diego, CA (US); Erik Colban, San Diego, CA (US); Richard Franklin, San Diego, CA (US); Vibhor Julka, San Diego, CA (US)

Correspondence Address: COATS & BENNETT, PLLC, P O BOX 5, RALEIGH, NC, 27602, US

(21) Appl. No.: 10/955,793

(22) Filed: Sep. 30, 2004

(51) Int. Cl. H04Q 7/20

(52) U.S. Cl. 455/436

(57) ABSTRACT

A handoff method in a wireless communication network enables radio configuration selection information to be exchanged between target and source base stations (BSs) involved in the handoff. For example, a source BS may determine that a given mobile station's Forward Supplemental Channel (F-SCH) should be handed off to a target BS in the mobile station's active set and thus send a handoff request to that target BS. In turn, the target BS selects a radio configuration and returns selection information to the source BS as part of its response. For example, the target BS may select a radio configuration that makes the best use of its available resources. Further, the source BS can include compatibility information in the request, such as a list of radio configurations compatible with the mobile station. In an exemplary cdma2000 embodiment, the source and target BSs use A3/A7 signaling to exchange radio configuration information.

### BACKGROUND OF THE INVENTION

The present invention generally relates to wireless communication networks, and particularly relates to managing base station resource usage during call handoffs.

Wireless communication networks, such as those based on IS-2000 or W-CDMA standards, typically use a number of geographically distributed base stations to provide radio coverage in a plurality of potentially overlapping areas to mobile stations operating in, and moving between, those areas. However, the resources available at each base station limit the number of mobile stations that can be simultaneously supported in base station's corresponding service areas, and limit the data rates that can be supported for those mobile stations.

As used herein, the term “base station” (BS) denotes radio and control resources used to carry traffic and control signaling between the network and one or more mobile stations. That collection of network and radio resources often is also referred to as a Base Station System (BSS). In cdma2000 networks, BSs comprise a Base Station Controller (BSC) and one or more Base Transceiver Stations (BTSs). BTSs are often referred to as Radio Base Stations (RBSs). Other network standards may define BSs and/or BSSs differently, but the overall functionality is the same or similar.

The underlying point is that BS resource availability for a given radio cell limits the number of mobile stations that can be simultaneously supported in that cell, and limits the corresponding data rates that can be supported for those mobile stations. In this context, such resources include but are not limited to forward link transmit power resources and forward link spreading code resources. Simply put, the amount of total available transmit power, e.g., 20 Watts, and the total number of orthogonal (or semi-orthogonal) spreading codes available at the BS must be allocated among the mobile stations—more generically, the “users”—being supported by the BS. Thus, running out of either transmit power or spreading code resources at a given BS typically results in blocking new users from being admitted and/or in compromising service to existing users.

The resources needed to support each user depend on a number of variables. For example, cdma2000 networks based on the IS-2000 family of standards define various radio configurations (RC1 through RC10 on the forward link, and RC1 through RC7 on the reverse link). Different radio configurations may have characteristically different transmit power and spreading code requirements, so one radio configuration may offer the ability to transmit at lower power at the expense of greater spreading code usage, or vice versa.

As an example, both RC3 and RC4 as defined by the standards may be used to transmit on Forward Fundamental Channels (F-FCH) or Supplemental Channels (F-SCHs) to a given mobile station. RC4 uses rate 1/2 convolutional encoding instead of the rate 1/4 coding used by RC3. Those skilled in the art will appreciate that, for a given rate of transmission and target error performance, this weaker coding makes RC4 less power efficient, but more efficient in terms of the code space consumed. For example, In the case of a voice user, a length 64 ‘parent’ Walsh code used with RC3 consumes 1/64th of the code space, which could instead accommodate two RC4 users each with a length 128 ‘child’ code. Therefore it will be advantageous to admit a user with RC4 instead of RC3 in cases where the Walsh resources are more precious to the system than power resources.

Ideally, call admission/connection processing in a cdma2000 network thus would select between RC3 and RC4, and other types of networks might make similar admission choices, to more efficiently balance BS resource utilization. Unfortunately, many such configuration choices must be made in the context of inter-BS call handoff from a source BS to a target BS, and no mechanism currently exists for the source and target BSs to select and/or change to a radio configuration that will maximize, or at least help balance, the various resource usages at the target BS.

### SUMMARY OF THE INVENTION

The present invention comprises a method and apparatus enabling the exchange of radio configuration information between target and source base stations during call handoff, thereby enabling the target base station to select the radio configuration it will use to support the handoff. The ability to select a radio configuration at the target base station and return that selection information to the source base station allows the target base station to use a radio configuration that, for example, makes the best use of available radio resources at the target base station. Further, as part of the handoff exchange, the source base station may provide compatibility information to the target base station to ensure that the target base station selects a radio configuration that is compatible with the mobile station.

In one or more embodiments, the source and target base station comprise cdma2000 base station systems, including base station controllers configured to exchange radio configuration information for Forward Supplemental Channel (F-SCH) handoff via A3/A7 interface signaling. Because F-SCHs can consume significant base station resources, they generally are supported by one active set sector at a time, and moved (handed off) as needed from sector to sector. Thus, for a given mobile station's F-SCH, the present invention enables a source base station to send a handoff request to a target base station and, in return, receive selection information from the target base station indicating the radio configuration selected by the target for supporting the mobile station's F-SCH. As noted, the target base station controller may choose a compatible radio configuration that makes the best use of currently available resources at the target, e.g., a radio configuration that tends to balance radio resource usage at the target.

With respect to target base station processing, the present invention comprises a base station for use in a wireless communication network comprising a base station controller configured to receive a handoff request from a source base station for handing off a mobile station call from the source base station, select a radio configuration for supporting the mobile station call, and return an indication of the selected radio configuration to the source base station. With respect to source base station processing, then, the present invention comprises a base station controller configured to send a handoff request to a target base station to initiate handoff of a mobile station call to the target base station, receive an indication from the target base station identifying a radio configuration selected by the target base station for supporting the handoff, and transmit an indication of the selected radio configuration to the mobile station.

With the above exemplary embodiment in mind, the present invention may be broadly understood as comprising a method of handoff between base stations in a wireless communication network based on receiving a handoff request at a target base station from a source base station for a mobile station call, selecting a radio configuration at the target base station for supporting the mobile station call, and indicating the selected radio configuration to the source base station. In this context, the source base station may send radio configuration compatibility information in association with the handoff request, and the target base station may select a radio configuration based on the compatibility information. Preferably, the target base station selects a compatible radio configuration that tends to balance resource utilization at the target base station. In response to receiving the radio configuration selection information from the target base station, the source base station can then transmit configuration information to the mobile station via appropriate signaling.

Of course, the present invention is not limited to the above features and advantages. Those skilled in the art will recognize additional features and advantages of the present invention upon reading the following discussion, and upon viewing the accompanying figures.

### BRIEF DESCRIPTION OF THE DRAWINGS

FIG. 1 is a diagram of source and target base stations in a wireless communication network.

FIG. 2 is a diagram of additional exemplary details regarding the wireless network and base stations of FIG. 1.

FIG. 3 is a diagram of exemplary target base station processing logic in accordance with the present invention.

FIG. 4 is a diagram of exemplary source-target base station signaling in accordance with the present invention.

FIG. 5 is a diagram of an exemplary base station interface and processing circuits.

FIG. 6 is a diagram of an exemplary call handoff scenario in accordance with the present invention, wherein source and target base stations cooperatively initialize the F-SCH of a given mobile station at the target base station using a radio configuration selected by the target base station.

### DETAILED DESCRIPTION OF THE INVENTION

Wireless communication networks, such as cellular communication networks based on IS-2000 standards, i.e., cdma2000 networks, use a number of techniques to tailor the resources allocated to a given mobile station in accordance with the particular needs and capabilities of the mobile station. For example, the IS-2000 standards define nine radio configurations (RC1-RC10 on the forward link, and RC1-RC7 on the reverse link), each offering different information rate capabilities, which may be used to serve mobile stations.

The different radio configurations use different encoding rates and/or different modulation formats to achieve the various data rates and the different radio configurations therefore have differing characteristic resource utilization. For example, as noted earlier herein, RC3 and RC4 as defined by the IS-2000 standards both may be used for F-SCH service to a given mobile station, but one is relatively more “power friendly” (RC3) and one is relatively more “code friendly” (RC4). By way of non-limiting example, a target base station can more effectively balance its power and code resources when initializing a given mobile station's F-SCH if the target base station is permitted to choose whether RC3 or RC4 will be used to support the F-SCH.

In an exemplary network, then, a given base station might be configured to bias its call admission/connection processing toward the use of RC3 if power resources are low, or toward the use of RC4 if spreading code resources are low. Pending U.S. patent application Ser. No. 10/328,833, which was filed on 24 Dec. 2002, and is commonly assigned herewith, discloses exemplary resource balancing based on radio configuration selection, and is incorporated herein by reference.

However, while the above co-pending application details an exemplary basis for selecting a radio configuration at a given base station, the present invention enables target base stations to drive the selection process during inter-BS call handoff. As used herein, the term “inter-BS call handoff” denotes a situation where the BS currently in control of the radio and network resources utilized for a call, referred to as the “source BS”, requests radio resources from a neighboring BS, referred to as the “target BS”, to continue to support the call. The control of the call remains with the source BS after the requested resources from target BS have been added.

In such handoff scenarios, rather than being forced to use the radio configuration selected by the source base station, the present invention enables a target base station to make its own selection of the radio configuration and to communicate such selection information back to the source base station. Such target-based selection is enabled by the present invention's method of enabling the communication of radio configuration selection information between source and target base stations as part of call handoff processing. As part of that exchange, the target base station may send additional call configuration and support information to the source base station.

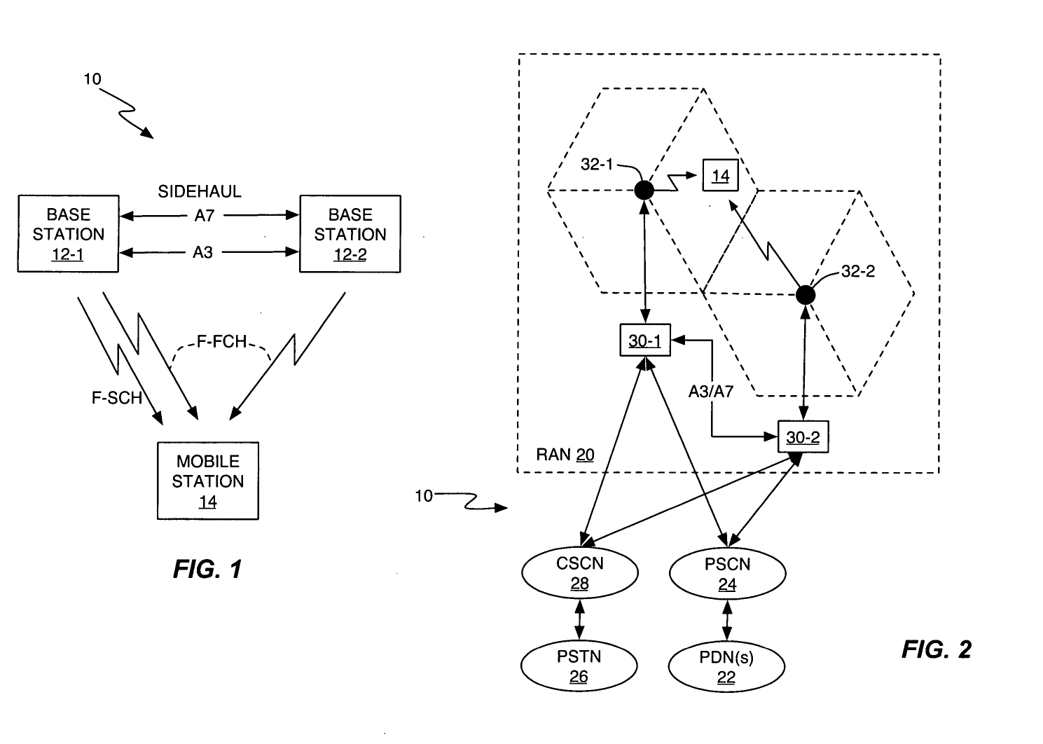

With that in mind, FIG. 1 partially illustrates a wireless communication network 10, which includes base stations (BSs) 12-1 and 12-2 providing communication support to a mobile station 14. In the illustrated scenario, BS 12-1 and BS 12-2 both support the mobile station's F-FCH in soft handoff, while only BS 12-1 supports the mobile station's F-SCH. Thus, for this example, the mobile station's “active set” includes pilots from BSs 12-1 and 12-2, and BS 12-1, operating as the currently serving BS for the F-SCH, can be configured to evaluate radio conditions as reported by the mobile station 14 to determine whether the F-SCH should be transferred (handed off) to another BS, i.e., handed off to another BS providing a soft handoff link in the mobile station's active set.

For example, the Periodic Pilot Strength Measurement Messages (PPSMMs) sent from the mobile station 14 may begin indicating that BS 12-2 offers better radio conditions than BS 12-1. That change may trigger a handoff of the F-SCH from BS 12-1 to BS 12-2. According to the present invention, the “sidehaul” links between base stations are used to exchange radio configuration selection information from the target BS to the source BS and, optionally, configuration compatibility information from the source BS to the target BS to aid in the target BS's selection processing.

FIG. 1 illustrates the use of BS-to-BS communications via A3/A7 sidehaul links as defined by the Interoperability Specifications (IOS) standards for cdma2000-based networks. In that context, FIG. 2 illustrates additional exemplary details for network 10, wherein a Radio Access Network (RAN) 20 communicatively couples mobile station 14 to one or more Public Data Networks (PDNs) 22, such as the Internet, via a Packet Switched Core Network (PSCN) 24. Optionally, RAN 20 also may communicatively couple mobile station 14 to the Public Switched Telephone Network (PSTN) 26 via a Circuit Switched Core Network (CSCN) 28.

In FIG. 2, RAN 20 includes a Base Station Controller (BSC) 30-1 that controls a Radio Base Station (RBS) 32-1, which provides sectorized coverage for a given radio cell, and wherein at least one such sector provides radio service to mobile station 14. Likewise, RAN 20 includes a BSC 30-2 that controls a RBS 32-2, which provides sectorized coverage in another, neighboring radio cell, and which also provides radio service to mobile station 14. In relating back to FIG. 1, it may be assumed for discussion purposes that source BS 12-1 comprises BSC 30-1/RBS 32-1, and that target BS 12-2 comprises BSC 30-2/RBS 32-2. Thus, in at least cdma2000 embodiments, the present invention involves the sidehaul exchange of information between source and target BSCs 30 in Base Station Systems (BSSs) comprising BSCs 30 and one or more RBSs 32.

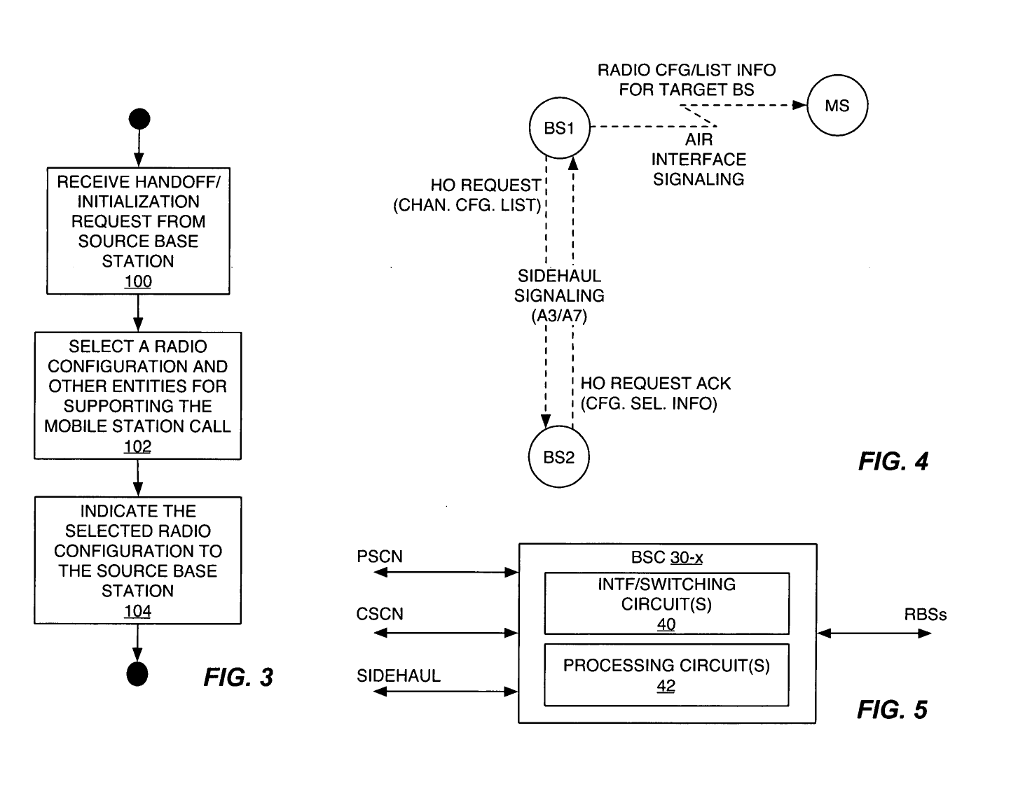

FIG. 3 illustrates exemplary target BS processing supporting such exchange, and it should be understood that BSCs 30-1 and 30-2 from FIG. 2 might be configured to carry out source and target BS processing. Such processing begins with the target BS receiving a handoff request from a source BS (Step 100), which, by way of non-limiting example, may arise in the context of the source BS handing off a pre-existing F-SCH, or from the source BS attempting to initialize a new F-SCH for the mobile station 14 at the target BS.

In response to receiving the request, the target BS selects a radio configuration to be used for supporting the call, and can select other parameters such as coding, etc. (Step 102). While in an exemplary embodiment, a target BSC 30 selects a radio configuration that makes the best use of radio resources at the involved RBS 32, e.g., a selection that tends to balance RBS resource usage, it should be understood that the present invention is not limited to such contexts. In other words, the present invention enables radio configuration selection by the target BS such that the radio configuration can be initialized or changed over, as needed, to the selection chosen by the target BS, and that target BS may make its selection for one or more of a variety of reasons.

Once the target BS makes its configuration and support entity selections, it returns configuration selection information to the source BS (Step 104), so that the source BS can signal such selection information as needed to the mobile station 14. In other words, upon identification of the radio configuration selected by the target BS, the source BS can signal mobile station 14 to use, or to otherwise change to, the radio configuration selected by the target BS.

Complementing the target-based processing of FIG. 3, FIG. 4 illustrates overall inter-entity signaling according to an exemplary embodiment of the present invention. For example, one sees that exemplary handoff processing begins with the source BS (BS1) sending a handoff request (e.g., an A7 Handoff Request message) to the target BS (BS2) via sidehaul signaling. The handoff request message can include compatibility information, such as a list of radio configurations the mobile station is compatible with, to be used by BS2 in its selection processing.

Thus, BS2 may select a radio configuration to be used for supporting the mobile station call based on the compatibility information provided by BS1. For example, assuming that BS1 indicates that more than one radio configuration is available for selection by BS2, BS2 may choose a particular one of the compatible configurations based on which configuration best complements its local needs, which may be based on BS2 determining which radio configuration best balances (or at least tends to balance) the usage of finite BS resources. As noted several times herein, such resources may comprise limited forward link transmit power resources, and limited forward link spreading code resources.

Regardless, BS2 returns an indication of the selected radio configuration to BS1 via sidehaul signaling. In cdma2000 embodiments, that indication may be returned as part of the A7 Handoff Request Ack message, which is used by the target BS to acknowledge the source BS's handoff request. With the acknowledgement thus providing BS1 with the radio configuration to be used by BS2, BS1 can then transmit information to mobile station 14 that identifies the selected configuration.

Thus, the present invention broadly comprises a method of handoff between BSs in a wireless communication network comprising sending a handoff request from a source BS to a target BS, selecting a radio configuration at the target BS for supporting the handoff responsive to the handoff request and returning an indication of the selected radio configuration to the source BS, and transmitting an indication of the selected radio configuration from the source BS to the mobile station being handed off. In an exemplary embodiment, selecting a radio configuration at the target BS for supporting the handoff responsive to the handoff request comprises selecting a radio configuration that is compatible with the mobile station being handed off and that tends to balance resource usage at the target BS.

Further, sending a handoff request from a source BS to a target BS comprises sending a list of available radio configurations in association with the handoff request message and wherein selecting a radio configuration at the target BS for supporting the handoff responsive to the handoff request comprises selecting a radio configuration from the list. Such selection may be based on selecting a radio configuration from the list based on the relative availabilities of forward link resources at the target BS—e.g., the selection may be made to better balance transmit power and spreading code resource usage at the target BS. Once the selection is made, the source BS can reconfigure the mobile station 14 as needed to use the selected radio configuration.

In supporting such operations, FIG. 5 illustrates an exemplary BSC 30 that comprises interface/switching circuits 40 to support communication call routing and PSCN/CSCN/RBS interfacing, and further comprises processing circuits 42 to support communication processing, and BSC/RBS control. Those skilled in the art should appreciate that processing circuits 42 may comprise, or at least include, one or more microprocessor circuits, that can be arranged in cards, racks, subsystems, etc. In any case, processing circuits 42 can be configured for exemplary source/target BSC processing in accordance with the present invention.

Thus, with respect to operation as a handoff target, an exemplary BS comprises a BSC 30 configured to receive a handoff request from a source BS for handing off a mobile station call from the source BS, select a radio configuration for supporting the mobile station call, and return an indication of the selected radio configuration to the source BS. In this role, the BSC can be configured to select the radio configuration from a list of radio configurations provided by the source BS, and that selection may be from a list of compatible radio configurations provided by the source BS based on the relative availabilities of forward link resources at the target BS. By way of non-limiting example, the source and target BSCs 30 may be included in cdma2000 BSs that carry out the BSC-to-BSC signaling using the A3/A7 sidehaul communication links defined by the IOS documents.

In the source BS role, the exemplary BSC 30 is configured to send a handoff request to a target BSC 30 to initiate handoff of a mobile station call to the target BSC 30, receive an indication from the target BSC 30 identifying a radio configuration selected by the target BSC 30 for supporting the handoff, and transmit an indication of the selected radio configuration to the mobile station 14. Supporting radio configuration selection by the target BSC 30, the source BSC can be configured to send radio configuration compatibility information to the target BSC 30 in association with the handoff request.

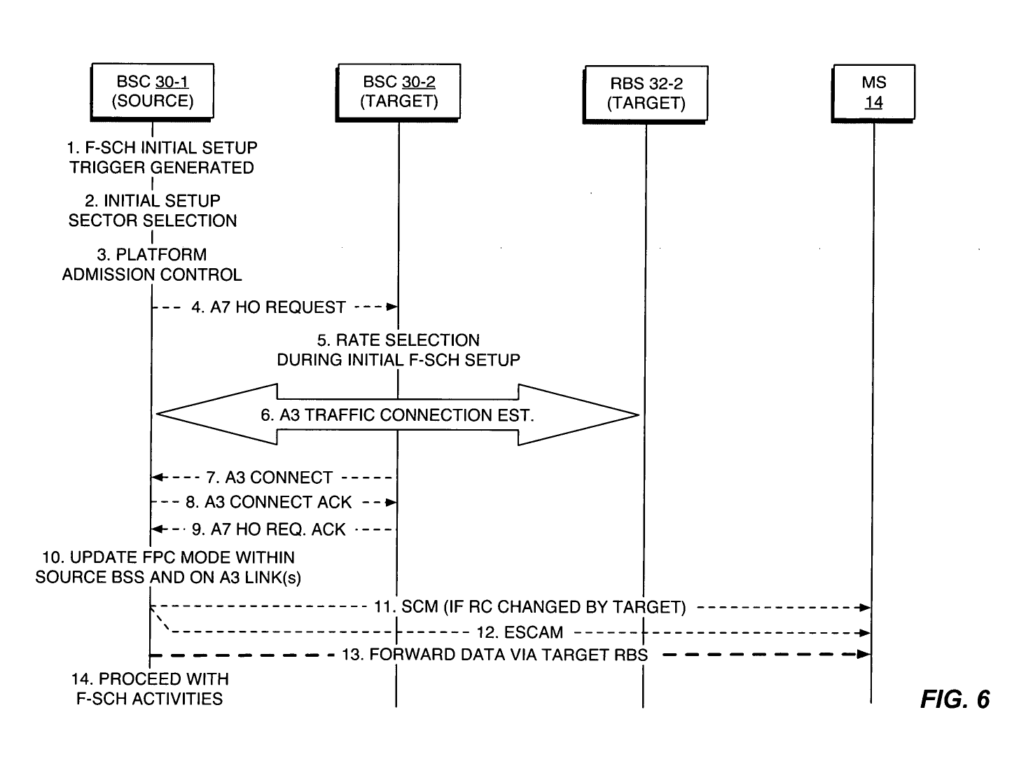

Continuing with exemplary processing examples, FIG. 6 illustrates the initialization of a F-SCH for a mobile station 14, wherein the mobile station's F-FCH is in soft handoff with two base stations, BS1 and BS2, which include source BSC 30-1 and target BSC 30-2, respectively. Thus, according to the depicted call flow at Step 1, the F-SCH initial setup is triggered by BSC 30-1 based on, for example, BSC 30-1 determining that a F-SCH should be setup for mobile station 14. At Step 2, BSC 30-1 determines that a radio link provided by a RBS 32 under control of the target BSC 30-2 is the best candidate for providing the F-SCH link to the mobile station 14.

Step 3 denotes that Platform Admission Control may be performed at the source BSC 30-1, wherein it is determined whether there is sufficient sidehaul bandwidth to carry F-SCH traffic for the mobile station 14, since the packet data for the F-SCH generally will be routed by the PSCN 24 to source BSC 30-1, and then transferred from there to the target BSC 30-2 across the A3/A7 sidehaul links. The illustrated call flow assumes that sufficient bandwidth exists and that call processing continues from that point.

Thus, at Step 4, source BSC 30-1 sends an A7 Handoff Request message to the target BSC 30-2 requesting it to setup an F-SCH for mobile station 14. BSC 30-1 may specify a requested F-SCH rate and may provide the mobile station's Radio Configuration (RC) capability, with such information included in or otherwise associated with the A7 Handoff Request message. Source BSC 30-1 may start a timer, T_{horeq}, which it uses to determine whether a timely handoff acknowledgment is received from the target BSC 30-2.

As indicated at Step 5, the target BSC 30-2 may call rate selection processing logic to determine the data rate and RC for the F-SCH setup. The target BSC 30-2 also performs radio admission control to reserve Walsh code and transmit power resources at the selected radio sector. Of course, if the target BSC 30-2 does not have sufficient radio resources to setup the F-SCH link, it may signal such setup failure to source BSC 30-1, which can then undertake alternative F-SCH setup procedures.

Assuming that sufficient resources are available, at Step 6 the target BSC 30-2 initiates setup of the A3 traffic connection from the target RBS 32-2 to the source BSC 30-1. However, the source BSC 30-1 generally does not transmit any F-SCH frames until a specified F-SCH start time, and the target RBS 32-2 does not starts transmission until it receives valid F-SCH frames for the mobile station 14, which may be routed from the source BSC 30-1 to the target BSC 30-2 across the A3/A7 sidehaul links.

Again, assuming no setup failures, at Step 7, the target BSC 30-2 then sends an A3 Connect message to the source BSC 30-1 to complete establishment of the A3 traffic connection to the source BSC 30-1. At Step 8, the source BSC 30-1 returns an A3 Connect Ack message to confirm setting up of the A3 traffic connection. Note that the target BSC 30-2 may run an A3 connection timer and undertake timeout processing if an acknowledgement is not timely returned by the source BSC 30-1. Upon receiving the A3 Connect Ack, any such timers are stopped and, at Step 9, the target BSC 30-2 sends an A7 Handoff Request Ack message to the source BSC 30-1 that preferably includes the actual F-SCH data rate and selected RC that will be supported in the F-SCH setup at the target RBS 32-2.

At Step 10, the source BSC 30-1 then determines the FPC_MODE information for adding the F-SCH according to FPC_MODE Selection for SCH Add or Release processing. In accordance with this processing, the source BSC 30-1 sends an A3 Physical Transition Directive Message to all the source sectors of the associated F-FCH connection, i.e., to all soft handoff links supporting the mobile station's F-FCH.

After receiving the A7 Handoff Request Ack from the target BSC 30-2 with the result of SCH setup, if the RC selected at the target is different from the current RC, the source BSC 30-1 reconfigures the RC of mobile station 14 by sending a Service Connect message (SCM) with an explicit F-SCH start time (Step 11). The source BSC 30-1 may send the SCM in Quick Repeat (QR) mode. At Step 12, which generally is concurrent with Step 11, after receiving the A7 Handoff Request Ack from the target BSC 30-2 with the result of SCH setup, the source BSC 30-1 sends the Extended Supplemental Channel Assignment message (ESCAM) to the mobile station 14 in Quick Repeat (QR) mode with an explicit F-SCH start time. Once such processing is complete, at Step 13, the source BSC 30-1 starts sending F-SCH data bursts (i.e., F-SCH traffic) to the mobile station 14 at the specific F-SCH start time, and regular F-SCH related activities are continued (Step 14).

Thus, in one or more embodiments of the present invention, the standard A7 Handoff Request message sent from a source BS to a target BS can be modified to support to request allocation of resources to support Inter-BS soft/softer handoff for a mobile station call. In particular, the message can be modified to include RC compatibility information that can be used at the target BS to select a RC compatible with the mobile station 14 that is the subject of call handoff.

When a “Forward RC” Information Element (IE) is included in the A7 Handoff Request message, a 9-bit bitmap may be used to specify what RCs are supported by the mobile station 14. In the return A7 Handoff Request Ack message, a similar RC bitmap may be included. In an exemplary return message, then, the target BS can indicate the selected RC by marking the bit corresponding to selected configuration.

Table 1 below indicates an exemplary bit map/marking method that may be used to include RC compatibility information in the A7 Handoff Request message sent from source BSs to target BSs, and to include RC selection information in the A7 Handoff Request Ack messages returned from target BSs to source BSs.

TABLE 1
Exemplary Use of RC Information Elements in A7 HO Messages.

| 7 | 6 | 5 | 4 | 3 | 2 | 1 | 0 | Octet |
|---|---|---|---|---|---|---|---|---|
| Information Element Identifier (=0xF1H) | | | | | | | | 1 |
| Length | | | | | | | | 2 |
| RC8 | RC7 | RC6 | RC5 | RC4 | RC3 | RC2 | RC1 | 3 |

| | | |
|---|---|---|
| Reserved | RC9 | 4 |

For the above table's Information Element Identifier 0xF1H:

| | |
|---|---|
| Length | This field indicates the number of octets in this element |
| | following the Length field. |
| RC1-RC9 | The bit positions RC1 to RC9 can be used to specify either |
| | the RC capability or the selected RC depending on the |
| | usage. |

Since the A7 Handoff Request contains a Service Configuration Record (SCR) that indicates the mobile station's present RC, in some embodiments the target BS may indicate its RC preference by instead modifying that information element, or by not sending the above element in the case that the target BS's preference matches the mobile station's present configuration. The source BS may cope with these various possibilities by assuming that the chosen alternative is contained in the above element if present, or within the SCR if the above element is not present in the A7 Handoff Request Ack.

Of course, those skilled in the art should understand that alternative messaging methods could be adopted as needed or desired, and that all such alternatives for signaling RC information between source and target BSs are contemplated by the present invention. Further, those skilled in the art should appreciate that while the BS architectures and network arrangements described herein provide an exemplary basis for discussing inter-BS signaling but are not intended as limiting the present invention. Indeed, those skilled in the art should appreciate that the present invention is not limited to the foregoing illustrations, but rather is limited only by the following claims and their reasonable legal equivalents.

What is claimed is:

1. A method of handoff between base stations in a wireless communication network comprising:
receiving a handoff request at a target base station from a source base station for a mobile station call;
selecting a radio configuration at the target base station for supporting the mobile station call; and
indicating the selected radio configuration to the source base station.

2. The method of claim 1, wherein receiving a handoff request at a target base station from a source base station for a mobile station call comprises receiving radio configuration compatibility information in association with the handoff request.

3. The method of claim 2, wherein selecting a radio configuration at the target base station for supporting the mobile station call comprises selecting a radio configuration based on the compatibility information.

4. The method of claim 2, wherein selecting a radio configuration at the target base station for supporting the mobile station call comprises selecting a radio configuration that is compatible and that tends to balance resource utilization at the target base station.

5. The method of claim 1, wherein selecting a radio configuration at the target base station for supporting the mobile station call comprises selecting a radio configuration that tends to balance resource utilization at the target base station.

6. The method of claim 1, wherein selecting a radio configuration at the target base station for supporting the mobile station call comprises selecting a radio configuration that tends to balance the relative utilization of transmit power resources and spreading code resources at the target base station.

7. The method of claim 1, further comprising transmitting an indication of the selected radio configuration from the source base station to the mobile station.

8. The method of claim 1, wherein the wireless communication network comprises a cdma2000 network, and wherein receiving a handoff request at a target base station from a source base station for a mobile station call comprises receiving an A7 handoff request message from the source base station via A3/A7 interface signaling.

9. The method of claim 8, wherein indicating the selected radio configuration to the source base station comprises sending an indication of the selected radio configuration from the target base station to the source base station via A3/A7 interface signaling.

10. The method of claim 8, wherein receiving an A7 handoff request message from the source base station via A3/A7 interface signaling includes receiving radio configuration compatibility information from the source base station that identifies one or more radio configurations that are compatible with the source base station and with the mobile station, thereby enabling the target base station to select a compatible radio configuration.

11. A method of handoff between base stations in a wireless communication network comprising:
sending a handoff request from a source base station to a target base station;
selecting a radio configuration at the target base station for supporting the handoff responsive to the handoff request and returning an indication of the selected radio configuration to the source base station; and
transmitting an indication of the selected radio configuration from the source base station to the mobile station being handed off.

12. The method of claim 11, wherein selecting a radio configuration at the target base station for supporting the handoff responsive to the handoff request comprises selecting a radio configuration that is compatible with the mobile station being handed off and that tends to balance resource usage at the target base station.

13. The method of claim 11, wherein sending a handoff request from a source base station to a target base station comprises sending a list of available radio configurations in association with the handoff request message and wherein selecting a radio configuration at the target base station for supporting the handoff responsive to the handoff request comprises selecting a radio configuration from the list.

14. The method of claim 13, wherein selecting a radio configuration from the list comprises selecting a radio configuration from the list based on the relative availabilities of forward link resources at the target base station.

15. The method of claim 13, wherein selecting a radio configuration from the list comprises selecting a radio configuration from the list that tends to balance transmit power and spreading code resource usage at the target base station.

16. The method of claim 11, wherein transmitting an indication of the selected radio configuration from the source base station to the mobile station being handed off comprises part of reconfiguring the mobile station by the source base station to use the selected radio configuration.

17. A base station for use in a wireless communication network comprising a base station controller configured to:
receive a handoff request from a source base station for handing off a mobile station call from the source base station;
select a radio configuration for supporting the mobile station call; and
return an indication of the selected radio configuration to the source base station.

18. The base station of claim 17, wherein the base station controller is configured to select the radio configuration from a list of radio configurations provided by the source base station.

19. The base station of claim 17, wherein the base station controller is configured to select a radio configuration from a list of radio configurations provided by the source base station based on the relative availabilities of forward link resources at the base station.

20. The base station of claim 17, wherein the base station comprises a cmda2000 base station, and wherein the base station controller is configured to receive the handoff request and to return the indication of the selected radio configuration via A3/A7 signaling.

21. A base station for use in a wireless communication network comprising a base station controller configured to:
send a handoff request to a target base station to initiate handoff of a mobile station call to the target base station;
receive an indication from the target base station identifying a radio configuration selected by the target base station for supporting the handoff; and
transmit an indication of the selected radio configuration to the mobile station.

22. The base station of claim 21, wherein the base station controller is configured to send radio configuration compatibility information to the target base station in association with the handoff request.

23. The base station of claim 21, wherein the base station comprises a cmda2000 base station, and wherein the base station controller is configured to send the handoff request and to receive the indication from the target base station identifying the selected radio configuration via A3/A7 signaling.
